(19) United States
(12) Patent Application Publication
(10) Pub. No.: US 2016/0342974 A1
(43) Pub. Date: Nov. 24, 2016

(54) WIRELESS MOBILE PAYMENT DEVICE

(71) Applicant: Alibaba Group Holding Limited, Grand Cayman (KY)

(72) Inventors: Hua Feng, Hangzhou (CN); Hongbin Shi, Hangzhou (CN)

(21) Appl. No.: 15/146,228

(22) Filed: May 4, 2016

(30) Foreign Application Priority Data
May 19, 2015 (CN) 201510254927.2

(51) Int. Cl. G06Q 20/32; G06F 17/30; H04W 76/02

(52) U.S. Cl. CPC G06Q 20/322; G06Q 20/327; H04W 76/023; G06F 17/30864; G06Q 20/3227

(57) ABSTRACT

Disclosed are a server, devices and uses therefor for implementing wireless mobile payment. One embodiment of a server includes a processor and a storage medium. The storage medium tangibly stores thereon program logic for execution by the processor. The program logic comprises first information receiving logic and registering logic. The first information receiving logic is executed by the processor for receiving first information sent by a client. The first information comprises transaction information and an identifier of a cash registering device that has established a wireless communication session with the client. The cash registering device comprises a mobile computing device capable of transmitting a wireless signal to facilitate making a payment. The registering logic is executed by the processor for registering the transaction information comprised in the first information into a merchant account corresponding to the identifier of the cash registering device.

### CROSS REFERENCE TO RELATED APPLICATIONS

This application claims the benefit of priority of Chinese Application No. 201510254927.2, titled “Payment Method and System Thereof, Collection Equipment and Client”, filed on May 19, 2015, which is hereby incorporated by reference in its entirety.

### TECHNICAL FIELD

The present disclosure relates to the field of wireless communication, and in particular, relates to devices for implementing payment and methods of deploying and using such devices.

### BACKGROUND

With the popularity of mobile terminals, mobile payment is becoming a commonly used payment method for people. Mobile payment typically provides convenience and speed for its user in making a payment.

During the process of mobile payments, a beneficiary party generally needs to use a computer, a mobile phone, a tablet, or the like, and needs to connect to a payment platform server via the Internet in order to complete the collection of a payment. The beneficiary party may not complete the collection of a payment when a beneficiary party device is not connected to the payment platform server via the Internet.

### SUMMARY

The present disclosure relates to implementing payments, in a scenario where a beneficiary party device is not connected to a payment platform server via the Internet. In one aspect, a method for implementing payments includes transmitting, by a cash registering device, a short-range wireless signal comprising an identifier of the cash registering device; receiving, by a client, the identifier of the cash registering device; acquiring transaction information and transmitting first information, by the client, to a server, the first information comprising the transaction information and the identifier of the cash registering device; and receiving, by the server, the first information sent by the client, and registering the transaction information comprised in the first information into a merchant account corresponding to the identifier of the cash registering device.

In another aspect, a method for implementing payments includes: transmitting a short-range wireless signal comprising an identifier of a cash registering device; establishing a wireless connection with a client; generating a session identifier; sending the session identifier to the client via the established wireless connection; receiving a transaction result and the session identifier returned by the client; and verifying whether the received session identifier matches the generated session identifier, and if the received session identifier matches the generated session identifier, generating voice information according to the transaction result and playing the voice information.

In one embodiment, the method includes receiving a wireless broadcast signal from the cash registering device; extracting the identifier of the cash registering device from the wireless broadcast signal; receiving transaction information input by the user; packaging the identifier of the cash registering device and the transaction information into first information, and sending the first information to a server; receiving a transaction result transmitted by the server; and sending the received transaction result to the cash registering device.

In one aspect, a system for implementing payments comprises a cash registering device and a server, wherein: the cash registering device is configured to send a short-range wireless signal comprising an identifier of the cash registering device; and the server is configured to receive first information sent by a client, the first information comprising transaction information and the identifier of the cash registering device; and the server is further configured to register the transaction information comprised in the first information into a merchant account corresponding to the identifier of the cash registering device.

In one embodiment, the cash registering device includes a wireless signal first sending unit and a first receiving unit, wherein: the first sending unit is configured to send a short-range wireless signal comprising an identifier of the cash registering device; the first receiving unit is configured to receive a returned transaction result and play the transaction result.

The cash registering device may further include: a first returning unit, configured to return the transaction result confirmation information to a client. The cash registering device may also include: a first connection establishing unit, configured to establish a wireless connection with a client; a generating unit, configured to generate a session identifier; a second sending unit, configured to send the session identifier to the client via the established wireless connection; a second receiving unit, configured to receive a transaction result and the session identifier returned by the client; a verifying unit, configured to verify whether the received session identifier matches the generated session identifier; and a playing unit, configured to, when a verification result obtained by the verifying unit indicates that the received session identifier matches the generated session identifier, play the transaction result.

In one aspect, a client includes: a third receiving unit, configured to receive the identifier of the cash registering device; an acquiring unit, configured to acquire transaction information; a third sending unit, configured to send first information to a server, the first information comprising the transaction information and the identifier of the cash registering device; a fourth receiving unit, configured to receive a transaction result returned by the server; and a fourth sending unit, configured to send the received transaction result to the cash registering device.

In one embodiment, the cash registering device broadcasts a Bluetooth signal, wherein the Bluetooth signal comprises identifier information; if the Bluetooth signal is received by a terminal, the cash registering device establishes a Bluetooth connection with the terminal; and the cash registering device generates a token, and sends the token to the terminal. The cash registering device receives the encrypted transaction result and token forwarded by the terminal; decrypts the transaction result and token respectively; verifies whether the token is correct, and plays the transaction result if the token is correct. In this way, even without the Internet, the beneficiary party confirms the payment information via Bluetooth.

### BRIEF DESCRIPTION OF THE DRAWINGS

In the drawing figures, which are not to scale, and where like reference numerals indicate like elements throughout the several views:

FIG. 1 is an architectural diagram of a system for implementing payments according to an embodiment of the present disclosure;

FIG. 2 is a flowchart of a method for implementing payments according to an embodiment of the present disclosure;

FIG. 3 is a flowchart of a method for implementing payments according to an embodiment of the present disclosure;

FIG. 4 is a flowchart of a method for implementing payments according to an embodiment of the present disclosure;

FIG. 5 is a flowchart of a method for implementing payments according to an embodiment of the present disclosure;

FIG. 6 is a flowchart of a method for implementing payments according to an embodiment of the present disclosure;

FIG. 7 is a flowchart of a method for implementing payments according to an embodiment of the present disclosure;

FIG. 8 is a flowchart of a method for implementing payments from the perspective of the cash registering device according to an embodiment of the present disclosure;

FIG. 9 is a flowchart of a method for implementing payments from the perspective of the cash registering device according to an embodiment of the present disclosure;

FIG. 10 is a flowchart of a method for implementing payments from the perspective of the cash registering device according to an embodiment of the present disclosure;

FIG. 11 is a flowchart of a method for implementing payments from the perspective of a client according to an embodiment of the present disclosure;

FIG. 12 is a flowchart of a method for implementing payments from the perspective of the client according to an embodiment of the present disclosure;

FIG. 13 is a flowchart of a method for implementing payments from the perspective of the client according to an embodiment of the present disclosure;

FIG. 14 is a flowchart of a method for implementing payments from the perspective of the client according to an embodiment of the present disclosure;

FIG. 15 is a flowchart of a method for implementing payments from the perspective of the client according to an embodiment of the present disclosure;

FIG. 16 is a module diagram of a cash registering device according to an embodiment of the present disclosure;

FIG. 17 is a module diagram of a cash registering device according to an embodiment of the present disclosure;

FIG. 18 is a module diagram of a cash registering device according to an embodiment of the present disclosure;

FIG. 19 is a module diagram of a client according to an embodiment of the present disclosure; and

FIG. 20 is a module diagram of a client according to an embodiment of the present disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered subject matter is intended to be construed as not being limited to any example embodiments set forth herein; example embodiments are provided merely to be illustrative. Likewise, a reasonably broad scope for covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the disclosure, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

A computing device may operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems.

A client device may vary in terms of capabilities or features. Disclosed subject matter is intended to cover a wide range of potential variations. For example, a simple smart phone, phablet or tablet may include a numeric keypad or a display. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

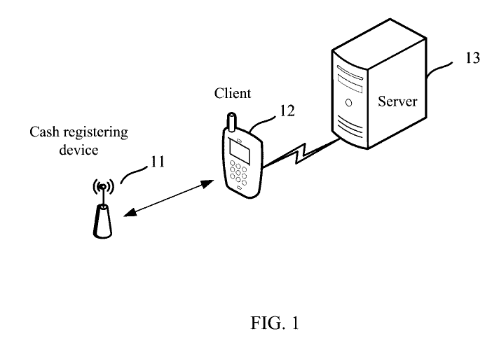

FIG. 1 is an architectural diagram of a system for implementing payments according to an embodiment of the present disclosure. In this embodiment, the system may comprise: a cash registering device 11, a client 12, and a server 13.

The cash registering device 11 can be any mobile computing device capable of transmitting a wireless signal to facilitate making a payment. A module suitable for short-range wireless communication may be integrated on the cash registering device 11, such as a Bluetooth module, an infrared (IrDA) module, a wireless local area network (WI-FI or WLAN, mostly based on the 802.11 protocol series) module, a Wi-Fi direct connection (WiFi Direct) module, an ultra wide band communication module, a Zigbee module, a near field communication (NFC) module, and the like, to implement receiving and sending of short-range wireless signals.

In one embodiment of the present disclosure, the below description uses the Bluetooth technology as an example. The Bluetooth technology is a short-range wireless communication technology, which replaces data cables, and supports point to point and point to multi-point communications, such that quick and convenient information exchange is implemented among devices.

The client 12 may be a terminal on which an application is installed, for example, a mobile application installed in the Apple® iOS® system, an application installed in the Google® Android® system, or an application installed in the Microsoft® Windows®/Windows® Phone system. In combination with an installed application, the client 13 may communicate with the cash registering device 11 via Bluetooth.

The server 13 may be a server of a payment platform, used to complete verification of a payment-related information transfer and verification of a payment.

A merchant may install the cash registering device 11 for registering the payment in their shops. For example, the cash registering device 11 on which a Bluetooth module is integrated may be installed in a shop to perform the cash registering. In the process of an offline or online sale, a merchant may use the cash registering device 11 for registering the payment. Such a payment registering may be a pre-payment or a settlement after a transaction is made. For example, the client 12 may be a user's mobile terminal on which an application is installed. After a product or service transaction with the merchant is finalized, the user may make payment via the client 12. The server 13 may be the server of the payment platform as described above. The process of the cash registering between the cash registering device 11 deployed by the merchant and the client 12 described in an embodiment of the present disclosure generally needs information verification and accounting of the cash registering with the server 13 of the payment platform.

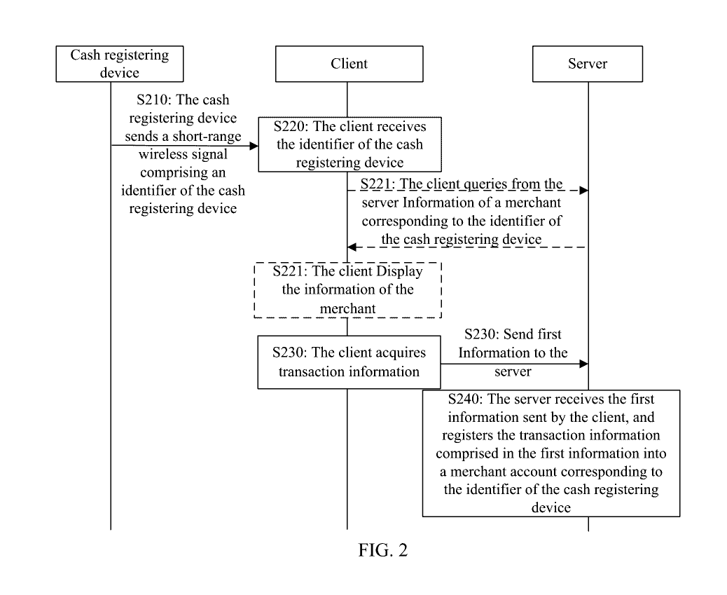

A method for implementing payment according to an embodiment of the present disclosure is described with reference to an example as illustrated in FIG. 2, wherein the method includes step S210: The cash registering device sends a short-range wireless signal comprising an identifier of the cash registering device.

The cash registering device may send the short-range wireless signal comprising the identifier of the cash registering device by broadcasting the wireless signal.

The broadcast short-range wireless signal may specifically be a Bluetooth signal, an infrared signal, a wireless local area network signal, a WiFi direct connection signal, an ultra wide band signal, a Zigbee signal, a near field communication signal or the like.

Still using the Bluetooth technology as an example, the cash registering device may send a broadcast signal comprising the identifier (UUID) of the cash registering device via a Bluetooth module. The Bluetooth module may be identified by using a universally unique identifier (UUID). Each UUID ensures the uniqueness of a Bluetooth service in time and space terms. Specifically, the UUID may be a short integer (16 or 32 bits) and a long integer (128 bits). The UUID may be sent via a Bluetooth broadcast signal.

In one embodiment, the Bluetooth technology may employ the technology of Bluetooth low energy (BLE). In one embodiment, the iBeacon® technology may be used. The iBeacon® technology is developed based on BLE, and has the characteristics of low cost, wide extension and flexible customization. The iBeacon® technology enables a smart phone or other devices to run a corresponding command within the sensing range of an iBeacon® base station. In the example of this embodiment, the cash registering device may be an iBeacon® base station. iBeacon® has been employed on the iOS (iOS7) of the mobile terminals released by Apple® Inc.

The communication manner of BLE generally includes two types: advertising and connecting. Advertising is a one-way sending mechanism, which is a broadcasting mode. Under such a mechanism, a to-be-searched device (for example, an iBeacon base station and a cash registering device) may send a plurality of data packets at time intervals of 20 milliseconds to 10 seconds. The shorter the employed time interval, the quicker the electricity consumption of the battery, and thus the faster the device is found. A data packet includes a maximum of 47 bytes, which is generally constituted by the following portions:

1 byte: preamble (1 byte is used for the packet header).

4 bytes: access address (4 bytes are used for the address).

39 bytes: advertising channel Protocol Data Unit (PDU) (39 bytes are used for the PDC data packet).

3 bytes: CRC (3 bytes are used for the CRC data check).

A BLE device may run in an advertising mode which is non-connectable (in such mode, all the information is contained in an advertising data packet). In addition, a BLE device may also run in a connectable mode.

The cash registering device in this embodiment may run in the non-connectable, advertising mode. As such, the cash registering device mainly sends out the identifier of the cash registering device in a broadcast mode. Specifically, the identifier of the cash registering device may be included in a PDU data packet as is described above.

The method can also include step S220: A client receives the identifier of the cash registering device.

Using Bluetooth technology as an example, the client may find the UUID of the cash registering device by scanning the broadcast Bluetooth signal. Specifically, the client installed on the terminal may actuate the terminal to scan the wireless signal by calling a bottom-layer application programming interface (API). In this way, the wireless signal sent by the cash registering device (for example, the Bluetooth signal sent in the broadcast mode) may be scanned. Since the Bluetooth signal sent by the cash registering device comprises the identifier information UUID of the cash registering device, the client may find the UUID by scanning the broadcast Bluetooth signal.

The method can also include step S230: The client acquires transaction information, and sends first information to a server.

The first information may comprise the transaction information and the received identifier of the cash registering device.

With respect to acquiring the transaction information, the client may receive an input operation of a user via a displayed interface element which may be input or selectable via a click, and thus receives the transaction information. Specifically, the transaction information comprises, for example, a transaction amount.

In one embodiment, in the process of acquiring the transaction information by the client, the user may have to verify a transaction password.

Between step S220 and step S230, the following step S221 may also be included.

S221: The client queries from the server information of a merchant corresponding to the identifier of the cash registering device and displays the information.

The client may initiate a query request and send it to the server to query the information of the merchant corresponding to the identifier of the cash registering device.

In one embodiment, the client initiating the query request and sending the query request to the server can be processed when the BLE device is run in a connectable mode (that is, the connecting mode), and, after the client establishes a connection with the server, the client can initiate the query request and send it to the server.

Through the query process, the merchant information corresponding to the identifier (UUID) of the cash registering device may be obtained. Thus, the client may display the queried information of the merchant in a webpage thereof, such that it facilitates the user verifying the merchant information before performing the subsequent payment steps, for example, confirming the payment to the displayed merchant.

The client may query from the server the information of the merchant corresponding to the identifier of the cash registering device via a data network established between the client and the server. For example, the information query may be performed via a wireless communication connection based on such technologies as GPRS, 3G, 4G, 5G, WiFi or the like.

Nevertheless, in this embodiment, step S221 may also be skipped.

S240: The server receives the first information sent by the client, and registers the transaction information comprised in the first information into a merchant account corresponding to the identifier of the cash registering device.

Upon receiving the first information sent by the client, based on the merchant account registered in the payment platform, the server may register the transaction information comprised in the first information into a merchant account corresponding to the cash registering device. Specifically, the server may register the transaction account comprised in the first information into the merchant account corresponding to the cash registering device. Thus, in one embodiment, the payment registering is completed by the server.

According to the above embodiments, a short-range wireless communication module is integrated on a merchant's cash registering device; a connection is established with a payment platform server without an Internet connection, an identifier of the cash registering device of the merchant may be sent to a client, such that the client may send transaction information and information comprising the identifier of the cash registering device to the server; upon receiving the information, the server may register the transaction information, thereby completing the payment.

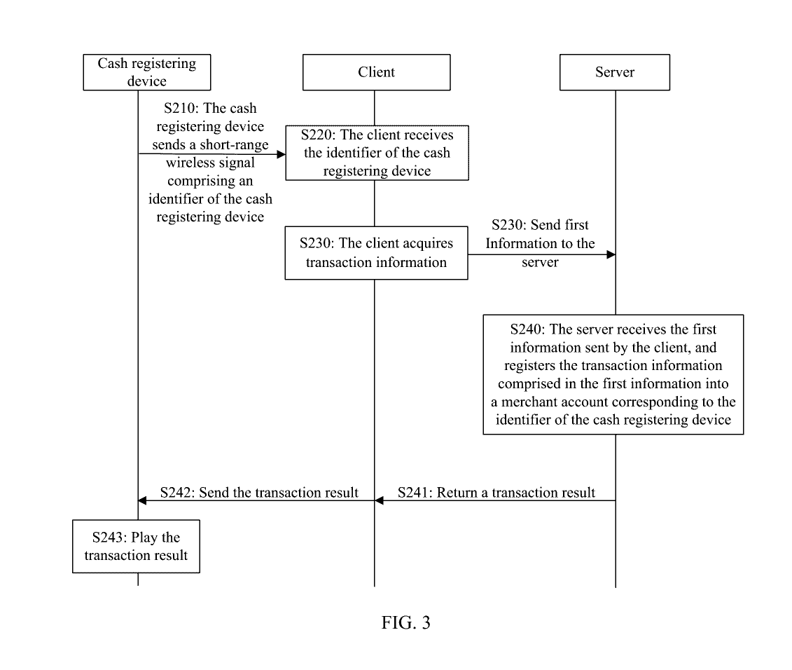

Based on the embodiments as illustrated in FIG. 2 of the present disclosure, as illustrated in FIG. 3, the method may further comprise one or more of the following steps:

S241: The server returns a transaction result to the client.

S242: The client sends the received transaction result to the cash registering device.

S243: The cash registering device plays the transaction result.

The server sends the transaction result to the client via the wireless connection, and the client sends the transaction result to the cash registering device via the short-range wireless connection. As such, the cash registering device may receive the transaction result without a need to establish a wireless connection between the cash registering device and the server.

The transaction result may be a file in the format of an animation, a picture and/or text. Upon receiving the transaction result, the cash registering device can play the transaction result, for example, by displaying the pictures or text, or playing videos or dynamic pictures, to notify the user of the client that the transaction is successful.

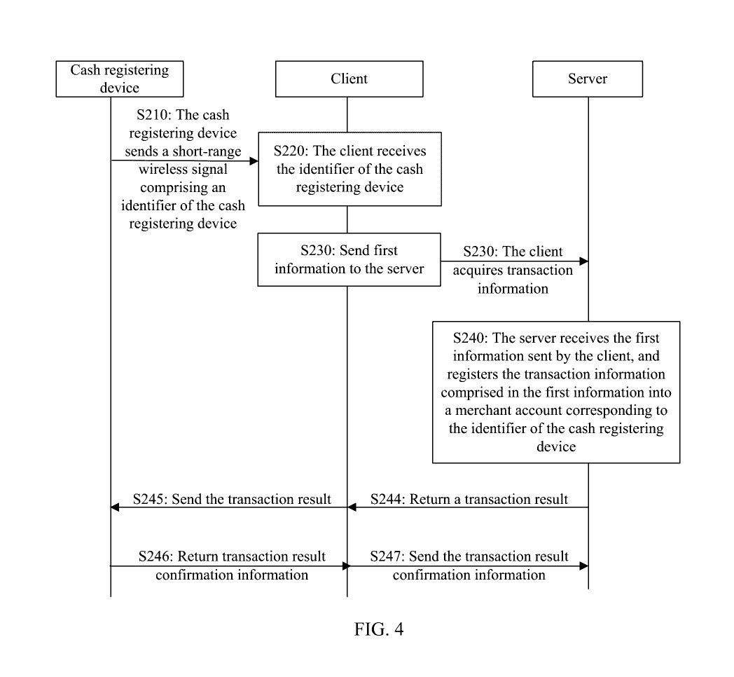

Based on the embodiments as illustrated in FIG. 2 of the present disclosure, as illustrated in FIG. 4, the method may further comprise one or more of the following steps.

S244: The server returns a transaction result.

S245: The client sends the received transaction result to the cash registering device;

S246: The cash registering device returns transaction result confirmation information to the client.

S247: The client sends the transaction result confirmation information to the server.

Upon receiving the transaction result, the cash registering device may return the transaction result confirmation information and may send the information to the server via the client. As such, the cash registering device may send the transaction result confirmation information to the server without establishing a wireless connection between the cash registering device and the server.

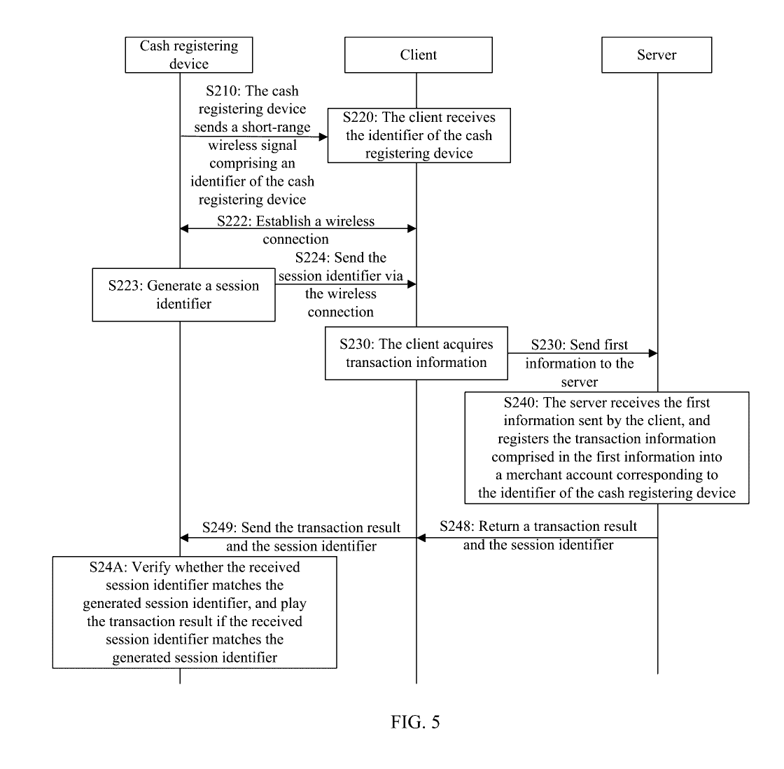

In an embodiment based on FIG. 2, the following steps, including S222 and 5223, may be performed between step S220 and step S230, and steps, including one or more of steps S248, S249 and S24A, may be performed after step S240, as illustrated in FIG. 5.

S222: The cash registering device establishes a wireless connection with the client.

S223: The cash registering device generates a session identifier, and sends the session identifier to the client via the wireless connection established with the client; correspondingly, the first information in step S230 may further comprise the session identifier; correspondingly, after step S240 as illustrated in FIG. 2, the method may further comprise one or more of the following steps:

S248: The server returns a transaction result and the session identifier to the client.

S249: The client sends the received transaction result and session identifier to the cash registering device.

S24A: The cash registering device verifies whether the received session identifier matches the generated session identifier, and plays the transaction result if the received session identifier matches the generated session identifier.

In the embodiments as illustrated in FIG. 5, the cash registering device may generate a session identifier and send the session identifier to the client. The current session may be identified by using this session identifier. As such, in step S203 of this embodiment, the session identifier, together with the transaction information and the device identifier, may be sent to the server. When the server returns a transaction result, the session identifier is also returned. In this way, when the cash registering device receives the returned transaction result and the session identifier, the cash registering device may verify, according to the received session identifier, whether the received session identifier corresponds to the session identifier generated in step S222, and thus determine whether the received transaction is the transaction result of this session.

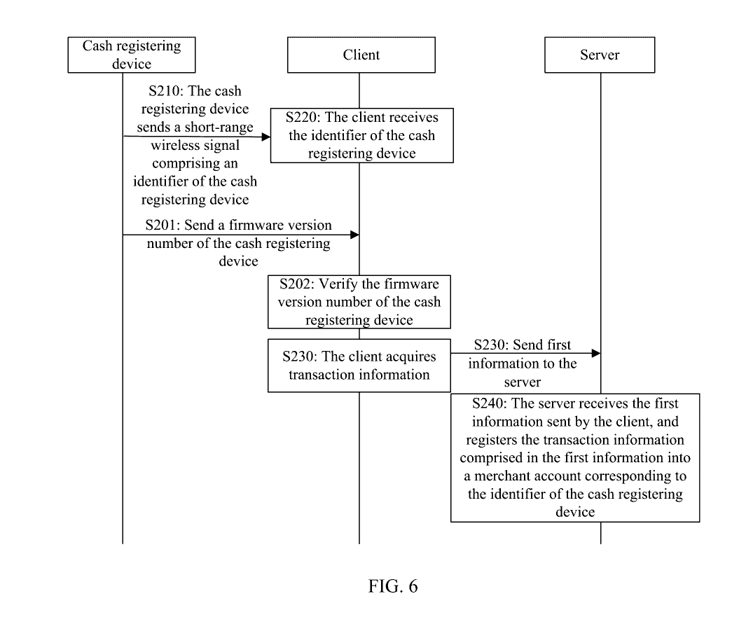

In one embodiment related to FIG. 2, prior to step S230, the method may further comprise one or more of the following steps, S201 and S202, as illustrated in FIG. 6.

S201: The cash registering device sends a firmware version number of the cash registering device to the client.

S202: The client verifies the firmware version number of the cash registering device.

Step S201 and step S202 may be, for example, performed prior to step S220. For example, the firmware version number may be sent to the client via the established wireless connection or in a broadcast manner. However, steps S201 and S202 may also performed between steps S220 and S230, which is not limited herein.

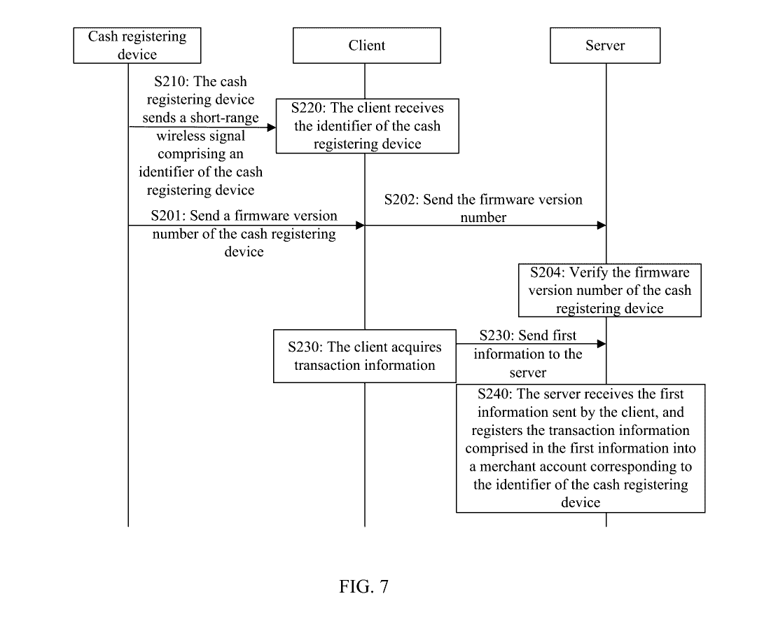

In one embodiment related to FIG. 2, prior to step S230, the method may further comprise one or more of the following steps S201, S203 and S204, as illustrated in FIG. 7.

S201: The cash registering device sends a firmware version number of the cash registering device to the client.

S203: The client sends the firmware version number to the server.

S204: The server verifies the firmware version number of the cash registering device.

Steps S201, S203 and S204 may be, for example, performed prior to step S220. For example, the firmware version number may be sent to the client via the established wireless connection or in a broadcast manner. However, steps S201, S203 and S204 may also performed between steps S220 and S230, which is not limited herein. In the embodiments as illustrated in FIG. 6 and FIG. 7, a firmware includes a program written into an erasable read-only memory (EROM) or an electrically erasable programmable read-only memory (EEPROM). Firmware serves as a basic and bottom-layer software of a system. Some hardware devices do not have any other software except the firmware. Therefore, a firmware determines functionality and performance of a hardware device. A firmware version refers to the version of the firmware. The firmware in different firmware versions may include different updates of the application portion and/or different updates of the baseband portion. Through the firmware updates, for example, updating a firmware from an earlier version to a later version, firmware bugs can be fixed and/or the performance can be optimized.

The cash registering device may send the firmware version number of the cash registering device in a broadcast manner.

After the cash registering device sends its firmware version number, the client or the server may verify whether the firmware used by the cash registering device is consistent with the corresponding program used by the client or the server, and whether the data transfer formats are consistent. As such, accuracy of information exchange may be ensured.

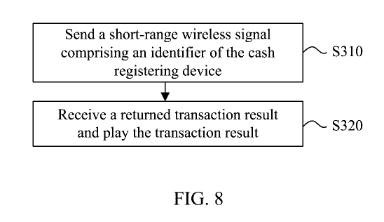

An embodiment of a method for implementing payments from the perspective of the cash registering device is shown in FIG. 8. Corresponding to FIG. 3, this embodiment may comprise one or more of the following steps:

S310: sending a short-range wireless signal comprising an identifier of the cash registering device; and

S320: receiving a returned transaction result and playing the transaction result.

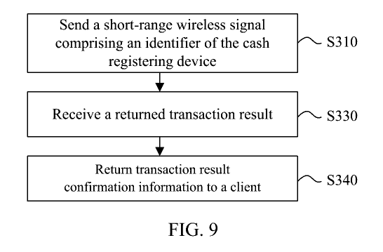

An embodiment of a method for implementing payments from the perspective of the cash registering device is shown in FIG. 9. Corresponding to FIG. 4, this embodiment may comprise one or more of the following steps:

S310: sending a short-range wireless signal comprising an identifier of the cash registering device;

S330: receiving a returned transaction result; and

S340: returning the transaction result confirmation information to a client.

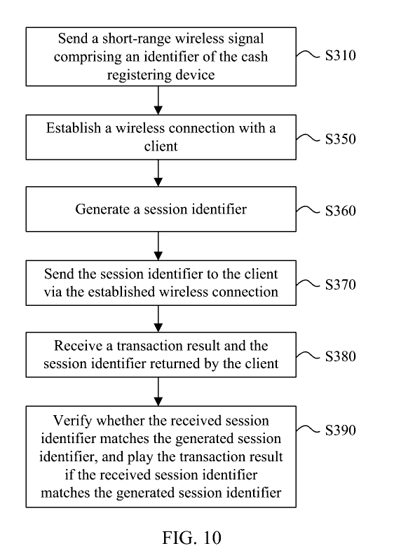

An embodiment of a method for implementing payments from the perspective of the cash registering device is shown in FIG. 10. Corresponding to FIG. 5, this embodiment may comprise one or more of the following steps:

S310: sending a short-range wireless signal comprising an identifier of the cash registering device;

S350: establishing a wireless connection with a client;

S360: generating a session identifier;

S370: sending the session identifier to the client via the established wireless connection;

S380: receiving a transaction result and the session identifier returned by the client; and

S390: verifying whether the received session identifier matches the generated session identifier, and playing the transaction result if the received session identifier matches the generated session identifier.

The firmware version number may be sent from the cash registering device to the client via the short-range wireless signal in step S310. Specifically, the firmware version number may be sent via a broadcast signal or the established wireless connection.

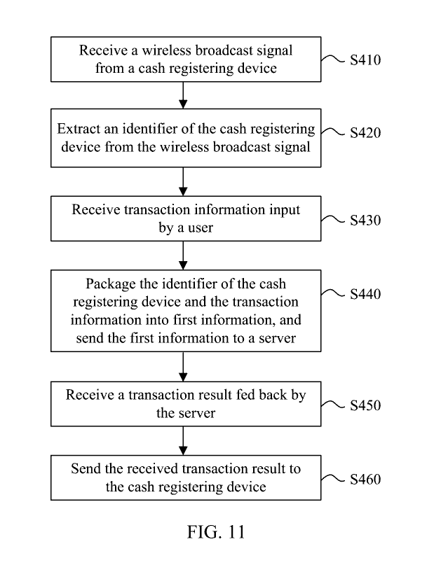

An embodiment of a method for implementing payments from the perspective of the client is shown in FIG. 11. This embodiment may comprise one or more of the following steps:

S410: receiving a wireless broadcast signal from the cash registering device;

S420: extracting an identifier of the cash registering device from the wireless broadcast signal;

S430: receiving transaction information input by a user;

S440: packaging the identifier of the cash registering device and the transaction information into first information, and sending the first information to a server;

S450: receiving a transaction result fed back by the server; and

S460: sending the received transaction result to the cash registering device.

In step S430, transaction information input by a user may be received.

The transaction information may comprise a transaction amount.

The process of acquiring the transaction information in step S430 may further comprise verifying a transaction password of the user.

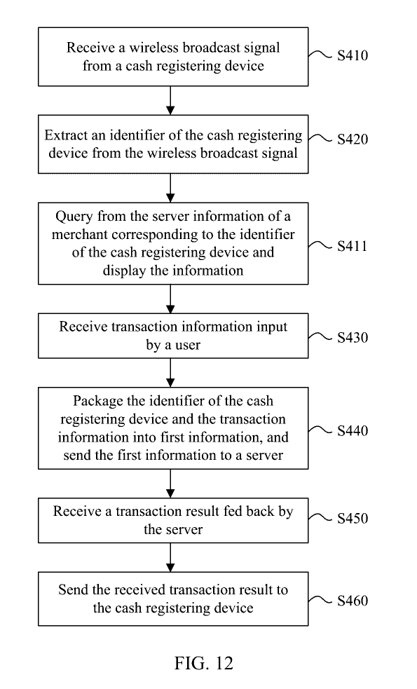

In another embodiment, as illustrated in FIG. 12, which is based on FIG. 11, the method may be described as follows.

In one embodiment, after the identifier of the cash registering device is received and prior to the acquisition of the transaction information, the method may further comprise the following step:

S411: querying, from the server, information of a merchant corresponding to the identifier of the cash registering device and displaying the information.

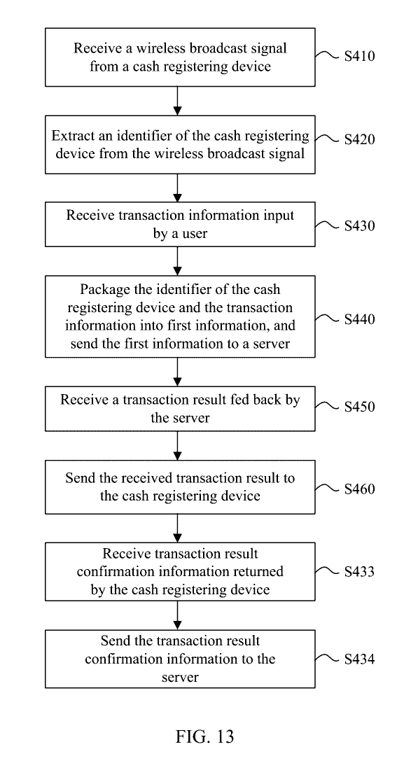

In another embodiment, as illustrated in FIG. 13, which is based on FIG. 11, the method may further comprise one or more of the following steps:

S433: receiving transaction result confirmation information returned by the cash registering device; and

S434: sending the transaction result confirmation information to the server.

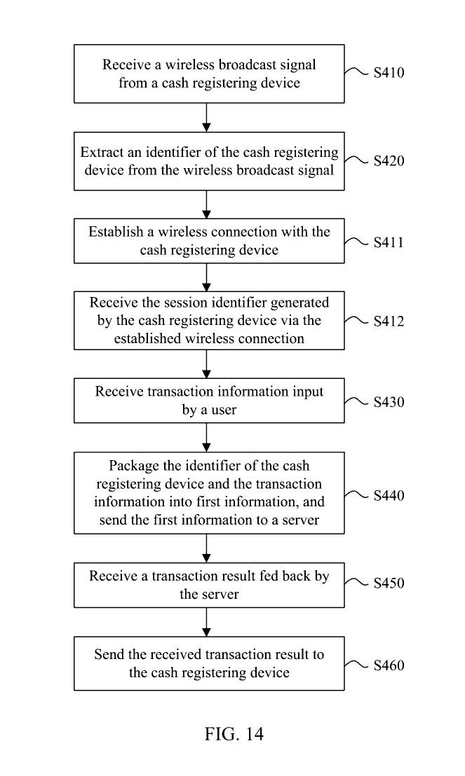

In another embodiment, as illustrated in FIG. 14, which is based on FIG. 11, the method may further comprise one or more of the following steps:

S411: establishing a wireless connection with the cash registering device;

S412: receiving the session identifier generated by the cash registering device via the established wireless connection; wherein the first information may comprise the session identifier; and correspondingly, the method may further comprise the following step:

S435: receiving the session identifier from the server, and sending the received session identifier to the cash registering device.

As such, subsequently the cash registering device verifies whether the received session identifier matches the generated session identifier, and plays the transaction result if the received session identifier matches the generated session identifier.

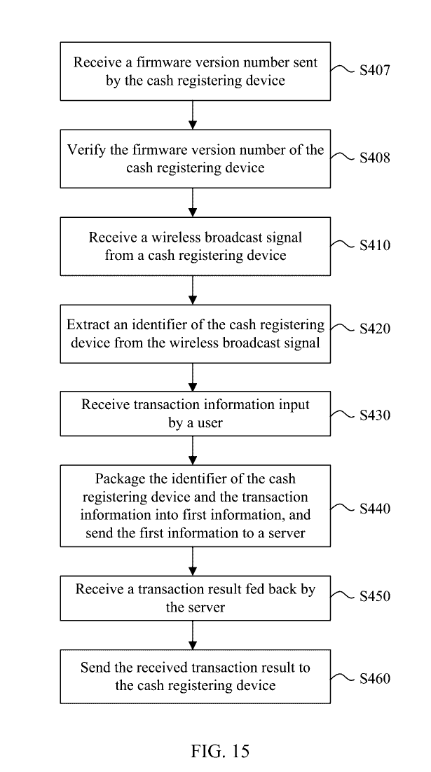

In another embodiment as illustrated in FIG. 15, which is based on FIG. 11, the method may further comprise one or more of the following steps:

S407: receiving a firmware version number of the cash registering device sent by the cash registering device; and

S408: verifying the firmware version number of the cash registering device.

In one embodiment, a system for implementing payments includes the cash registering device, and the server. The server is configured to receive first information sent by the client, the first information comprising transaction information and the identifier of the cash registering device; and the server is further configured to register the transaction information comprised in the first information into a merchant account corresponding to the identifier of the cash registering device.

In one embodiment, the server may further return a transaction result to the client.

In one embodiment, the cash registering device may further return the transaction result confirmation information to the client.

In one embodiment, the cash registering device may further establish a wireless connection with the client; the cash registering device may generate a session identifier, such that the cash registering device may further send the session identifier to the client via the established wireless connection.

In one embodiment, the identifier is a session identifier. The cash registering device may receive the transaction result and the session identifier that are sent by the client, verify whether the received session identifier matches the generated session identifier, and play the transaction result if the received session identifier matches the generated session identifier.

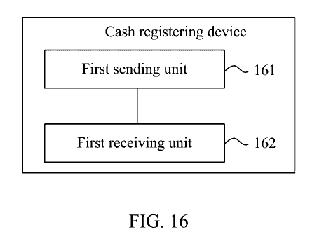

As illustrated in FIG. 16, the cash registering device may comprise a wireless signal sending unit 161 and a first receiving unit 162. The first sending unit 161 is configured to send the short-range wireless signal. The first receiving unit 162 is configured to receive the returned transaction result and play the transaction result.

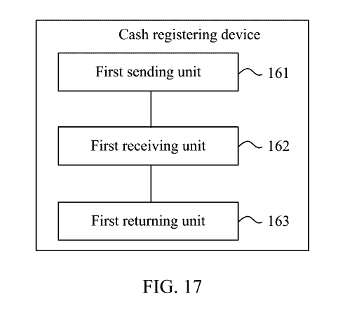

As illustrated in FIG. 17, the cash registering device may further include: a first returning unit 163, configured to return the transaction result to the client.

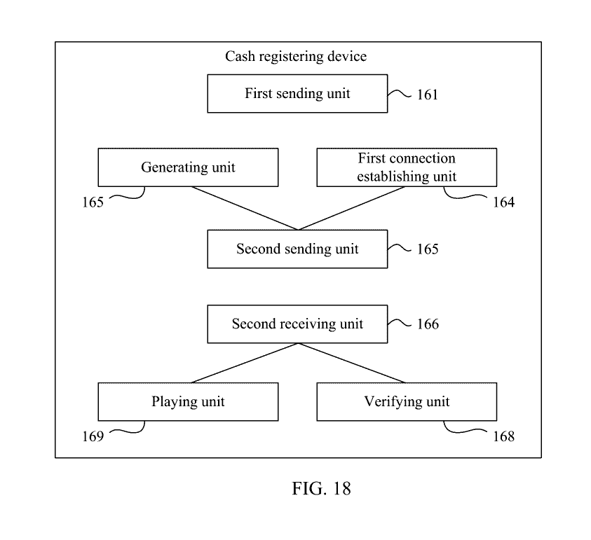

As illustrated in FIG. 18, the cash registering device may also include a first connection establishing unit 164, configured to establish a wireless connection with the client; a generating unit 165, configured to generate the session identifier; a second sending unit 166, configured to send the session identifier to the client via the established wireless connection; a second receiving unit 167, configured to receive the transaction result and the session identifier returned by the client; a verifying unit 168, configured to verify whether the received session identifier matches the generated session identifier; and a playing unit 169, configured to, when a verification result obtained by the verifying unit indicates that the received session identifier matches the generated session identifier, play the transaction result.

The cash registering device may also include a third sending unit 170, which is configured to send the firmware version number of the cash registering device to the client.

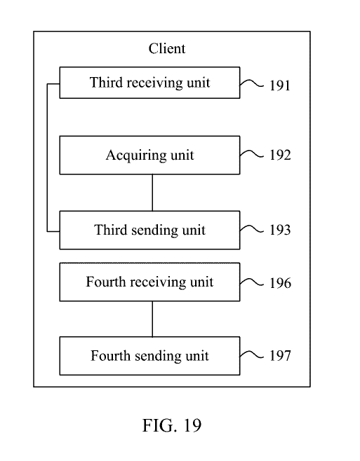

As illustrated in FIG. 19, the client may include a third receiving unit 191, configured to receive the identifier of the cash registering device; an acquiring unit 192, configured to acquire transaction information; a third sending unit 193, configured to send first information to a server, the first information comprising the transaction information and the identifier of the cash registering device; a fourth receiving unit 196, configured to receive a transaction result returned by the server; and a fourth sending unit 197, configured to send the received transaction result to the cash registering device.

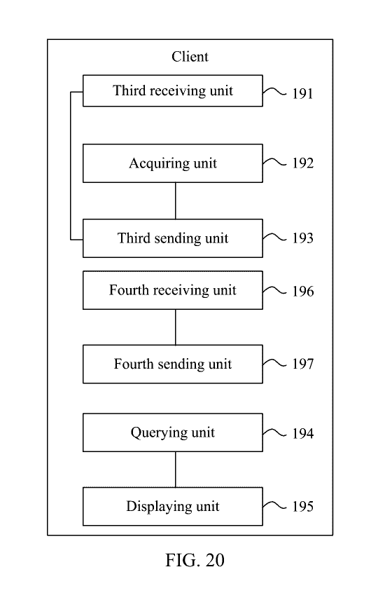

As illustrated in FIG. 20, the client may further include a querying unit 194, configured to query from the server information of a merchant corresponding to the identifier of the cash registering device; and a displaying unit 195, configured to display the information of the merchant.

The client may further include a fifth receiving unit, configured to receive transaction result confirmation information returned by the cash registering device; and a fifth sending unit, configured to send the transaction result confirmation information to the server.

The client may further include a sixth receiving unit, configured to receive the firmware version number of the cash registering device sent by the cash registering device; and a verifying unit, configured to verify the firmware version number of the cash registering device.

The client may further include a sixth sending unit, configured to send the firmware version number to the server. The acquiring transaction information may comprise receiving transaction information input by a user. The transaction information, in one embodiment, comprises a transaction amount. In one embodiment, the transaction information can include any information related to the transaction.

The client may further include a second connection establishing unit, configured to establish the wireless connection with the cash registering device; a seventh receiving unit, configured to receive the session identifier generated by the cash registering device via the established wireless connection; an eighth receiving unit, configured to receive the session identifier from the server; and an eighth sending unit, configured to send the received session identifier to the cash registering device.

The current improvements made to method processes in hardware or firmware are viewed as direct improvements in the hardware circuit structure. By programming the improved method processes to the hardware circuits, designers improve the corresponding hardware circuit structures. Therefore, an improvement of a method process may also be implemented into a hardware entity module. For example, the programmable logic device (PLD), (like the field programmable gate array (FPGA)), is such an integrated circuit, and the logical functions thereof are determined by its user's programming to the device. Designers generally write the programs by themselves to “integrate” a digital system on a PLD, with no need to request a chip manufacturer to design and fabricate the dedicated integrated circuit chip 2. In one embodiment, programming is implemented by using (“logic compiler”) software, which is similar to the software compiler used for drafting of the program. The compilation of the original code also needs the specific programming language, which is referred to as Hardware Description Language (HDL). There are a variety of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), and the like. Currently, the most common adopted languages are Very-High-Speed Integrated Circuit Hardware Description Language (VHDL) and Verilog2. People skilled in the art will understand that by performing some degrees of logic programming in the above-mentioned hardware description languages in the method process and applying the programming to integrated circuits, they can readily obtain a hardware circuit that implements the logic method process.

A controller may be implemented in various suitable manners. For example, a controller may be implemented in the form of a micro-processor or processor, a computer readable media storing computer readable program code (for example, software or firmware) which is executable by the (micro) processor, a logic gate, a switch, an application specific integrated circuit (ASIC), a programmable logical controller or an embedded microcontroller. Examples of a controller may include, but not limited to, the following microcontrollers: ARC 625D, Atmel AT91SAM, Microchip PIC18F26K20 and Silicone Labs C8051F320; and a memory controller may be implemented as a portion of the control logic of a memory. People skilled in the art are aware that the methods and steps may be completely performed via logic programming in the form of a logic gate, switch, application-specific integrated circuit, programmable logic controller, and embedded microcontroller to implement the same function in addition to implementing the controller by using a pure computer readable program code. Therefore, this kind of the controller is deemed as a hardware component; and a device for implementing various functions which is included in the controller may also be deemed as an inner structure of the hardware component. Or even, the device for implementing various functions may be deemed as a software module for implementing the methods, and deemed as an inner structure of the hardware component as well.

Systems, devices, modules, or units illustrated in the above embodiments may be implemented by using a computer chip or entity, or may be implemented by using products having specific functions.

For ease of description, descriptions for separate units were given based on functions of the above device. Nevertheless, the function of each unit can be implemented in the same or a plurality of software and/or hardware when the application is implemented.

Those skilled in the art shall understand that the embodiments may be described as illustrating methods, systems, or computer program products. Therefore, hardware embodiments, software embodiments, or hardware-plus-software embodiments may be used to illustrate the present disclosure. In addition, the present disclosure may further employ a computer program product which may be implemented by at least one computer-readable storage medium with an executable program code stored thereon. The computer-readable storage medium comprises, but not limited to, a disk memory, a CD-ROM, and an optical memory.

The present disclosure is described based on the flowcharts and/or block diagrams of the method, device (system), and the computer program product. It should be understood that each process and/or block in the flowcharts and/or block diagrams, and any combinations of the processes and/or blocks in the flowcharts and/or block diagrams may be implemented using computer program instructions. These computer program instructions may be sent to a computer, a dedicated computer, an embedded processor, or processors of other programmable data processing devices to generate a machine, which enables the computer or the processors of other programmable data processing devices to execute the instructions to implement a device for implementing specific functions in at least one process in the flowcharts and/or at least one block in the block diagrams.

These computer program instructions may also be stored in a computer-readable memory that can enable a computer or other programmable data processing devices to work in a specific mode, such that the instructions stored on the computer-readable memory yield a product that comprises the instruction device, wherein the instruction device implements specific functions in at least one process in the flowcharts and/or at least one block in the block diagrams.

These computer program instructions may also be stored on a computer or other programmable data processing devices, such that the computer or the other programmable data processing devices execute a series of operations or steps to implement processing of the computer. In this way, the instructions, when executed on the computer or the other programmable data processing devices, implement the specific functions in at least one process in the flowcharts and/or at least one block in the block diagrams.

In a typical configuration, a computing device comprises one or more central processing units (CPUs), input/output (I/O) interfaces, network interfaces, and memories.

The memory may include such computer-readable medium as a non-permanent memory, a random access memory (RAM) and/or other forms of nonvolatile memories, like a read only memory (ROM) or a flash memory (flash RAM). An example of the computer-readable medium is the memory.

The computer-readable mediums include permanent and non-permanent mediums, and removable and non-removable mediums which may implement information storage by using any method or technology. The information may be computer-readable instructions, data structures, program modules or other data. Examples of computer storage mediums include, but are not limited to, a phase change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, compact disc read-only memory (CD-ROM), a digital versatile disk (DVD) or other optical storage devices, a magnetic cassette, a magnetic tape magnetic disk storage device or other magnetic storage devices, or any other non-transmission mediums which may be used to store information that can be accessed by a computing device. According to the definition in this specification, the computer-readable medium does not include a transitory computer-readable medium, such as modulated data signals and carriers.

It should be noted that, in this specification, terms “comprises”, “comprising”, “has”, “having”, “includes”, “including”, “contains”, “containing” or any other variation thereof, are intended to cover a non-exclusive inclusion, such that a process, method, commodity, or device, that comprises, has, includes, contains a list of elements does not include only those elements but may include other elements not expressly listed or inherent to such process, method, commodity, or device. An element proceeded by “comprises . . . a”, “has . . . a”, “includes . . . a”, “contains . . . a” does not, without more constraints, preclude the existence of additional identical elements in the process, method, commodity, or device.

Those skilled in the art shall understand that the embodiments of the present disclosure may be described as illustrating methods, systems, or computer program products. Therefore, hardware embodiments, software embodiments, or hardware-plus-software embodiments may be used to illustrate the present disclosure. In addition, the present disclosure may further employ a computer program product which may be implemented by at least one computer-readable storage medium with an executable program code stored thereon. The computer-readable storage medium comprises but not limited to a disk memory, a CD-ROM, and an optical memory.

The present disclosure may be described in the general context of the computer executable instructions executed by the computer, for example, a program module. Generally, the program module comprises a routine, program, object, component or data structure for executing specific tasks or implementing specific abstract data types. The present disclosure may also be realized in the distributed computer environments. In such distributed computer environments, the tasks are executed by a remote device connected via a communication network. In the distributed computer environments, the program module may be located in the local and remote computer storage medium including the storage device.

Various embodiments in the specification are described in a progressive manner. The same or similar parts between the embodiments may be referenced to one another. In each embodiment, the portion that is different from other embodiments is focused and described. In particular, with respect to a system, since it is substantially similar to the method embodiment, a brief description is given. The related portions may be referenced to the description of the portions in the method embodiments.

The above details are exemplary embodiments of the present disclosure, and are not intended to limit the present disclosure. For people skilled in the art, the present disclosuremay be subjected to various modifications and variations. Any modification, equivalent replacement, or improvement made without departing from the spirit and principle of the present disclosureshould fall within the protection scope of the present disclosure.

1. A server comprising:
a processor;
a storage medium for tangibly storing thereon program logic for execution by the processor, the program logic comprising:
first information receiving logic executed by the processor for receiving first information sent by a client, the first information comprising transaction information and an identifier of a cash registering device that has established a wireless communication session with the client, the cash registering device comprising a mobile computing device capable of transmitting a wireless signal to facilitate making a payment; and
registering logic executed by the processor for registering the transaction information comprised in the first information into a merchant account corresponding to the identifier of the cash registering device.

2. The server according to claim 1, further comprising transaction result transmitting logic executed by the processor for transmitting a transaction result to the client.

3. A cash registering device, comprising:
a processor;
a storage medium for tangibly storing thereon program logic for execution by the processor, the program logic comprising:
wireless signal sending logic executed by the processor for sending a short-range wireless signal comprising an identifier of the cash registering device to a client to establish a wireless communication session with the client, the cash registering device capable of transmitting the short-range wireless signal to facilitate making a payment;
first receiving logic executed by the processor for receiving a returned transaction result and for playing the transaction result.

4. The cash registering device of claim 3, further comprising first returning logic executed by the processor for transmitting the transaction result to the client.

5. A cash registering device, comprising:
a processor;
a storage medium for tangibly storing thereon program logic for execution by the processor, the program logic comprising:
first sending logic executed by the processor for transmitting a short-range wireless signal comprising an identifier of the cash registering device;
first connection establishing logic executed by the processor for establishing a wireless connection with a client;
generating logic executed by the processor for generating a session identifier;
second sending logic executed by the processor for sending the session identifier to the client via the established wireless connection;
second receiving logic executed by the processor for receiving a transaction result and the session identifier from the client;
verifying logic executed by the processor for verifying whether the received session identifier matches the generated session identifier; and
playing logic executed by the processor for, when a verification result obtained by the verifying logic indicates that the received session identifier matches the generated session identifier, playing the transaction result.

6. The cash registering device according to claims 5, further comprising third sending logic executed by the processor for sending a firmware version number of the cash registering device to the client.

7. A client, comprising:
a processor;
a storage medium for tangibly storing thereon program logic for execution by the processor, the program logic comprising:
third receiving logic executed by the processor for receiving an identifier of a cash registering device in communication with the client, the cash registering device comprising a mobile computing device capable of transmitting a wireless signal to the client to facilitate making a payment;
acquiring logic executed by the processor for acquiring transaction information;
third sending logic executed by the processor for sending first information to a server in communication with the client, the first information comprising the transaction information and the identifier of the cash registering device;
fourth receiving logic executed by the processor for receiving a transaction result returned by the server; and
fourth sending logic executed by the processor for sending the received transaction result to the cash registering device.

8. The client according to claim 7, further comprising:
querying logic executed by the processor for querying, from the server, information of a merchant corresponding to the identifier of the cash registering device; and
displaying logic executed by the processor for displaying the information of the merchant.

9. The client according to claim 8, further comprising:
fifth receiving logic executed by the processor for receiving transaction result confirmation information returned by the cash registering device; and
fifth sending logic executed by the processor for sending the transaction result confirmation information to the server.

10. The client according to claim 8, further comprising:
sixth receiving logic executed by the processor for receiving a firmware version number of the cash registering device sent by the cash registering device; and
verifying logic executed by the processor for verifying the firmware version number of the cash registering device.

11. The client according to claim 8, further comprising:
sixth receiving logic executed by the processor for receiving the firmware version number of the cash registering device sent by the cash registering device; and
sixth sending logic executed by the processor for sending the firmware version number to the server.

12. The client according to claim 8, wherein the acquiring logic further comprises input receiving logic executed by the processor for receiving transaction information input by a user.

13. The client according to claim 8, wherein the transaction information comprises a transaction amount.

14. The client according to claim 8, further comprising:
second connection establishing logic executed by the processor for establishing a wireless connection with the cash registering device;
eighth receiving logic executed by the processor for receiving the session identifier generated by the cash registering device via the established wireless connection;
ninth receiving logic executed by the processor for receiving the session identifier from the server; and
eighth sending logic executed by the processor for sending the received session identifier to the cash registering device.

15. A method comprising:
receiving, by a client, a wireless signal comprising an identifier of a cash registering device, the cash registering device comprising a mobile computing device capable of transmitting the wireless signal to facilitate making a payment;
acquiring, by the client, transaction information associated with the payment;
transmitting, by the client, first information to a server, the first information comprising the transaction information and the identifier of the cash registering device to enable the server to register the transaction information of the first information into a merchant account corresponding to the identifier of the cash registering device.

16. The method according to claim 15, wherein the wireless signal comprises a signal selected from a group of signals consisting of a Bluetooth signal, an infrared signal, a wireless local area network signal, a WiFi direct connection signal, an ultra wide band communication signal, a Zigbee peak signal, or a near field communication signal.

17. The method according to claim 15, wherein the identifier comprises a universally unique identifier.

18. The method according to claim 15, wherein the acquired transaction information by the client comprises receiving, by the client, transaction information input by a user.

19. The method according to claim 15, wherein the transaction information comprises a transaction amount.

20. The method according to claim 15, wherein the acquiring of the transaction information further comprises verifying a transaction password of a user.

21. The method according to claim 15, further comprising:
querying, by the client from the server, information of a merchant corresponding to the identifier of the cash registering device; and
displaying the information.

22. The method according to claim 15, further comprising:
receiving, by the client from the server, a transaction result; and
transmitting, by the client, the received transaction result to the cash registering device so that the cash registering device can play the transaction result.

23. The method according to claim 15, further comprising:
receiving, by the client, a transaction result;
transmitting, by the client, the received transaction result to the cash registering device;
receiving, by the client from the cash registering device, transaction result confirmation information; and
transmitting, by the client, the transaction result confirmation information to the server.

24. The method according to claim 15, further comprising:
receiving, by the client from the cash registering device, a session identifier generated by the cash registering device via an established wireless connection between the client and the cash registering device;
wherein the first information comprises the session identifier; and
wherein the method further comprises:
receiving, by the client from the server, a transaction result and the session identifier; and
transmitting, by the client, the received transaction result and session identifier to the cash registering device so that the cash registering device can verify whether the received session identifier received by the cash registering device matches the generated session identifier, and further can play the transaction result if the received session identifier matches the generated session identifier.

25. The method according to claim 15, further comprising:
receiving, by the client from the cash registering device, a firmware version number of the cash registering device ; and
verifying, by the client, the firmware version number of the cash registering device.

26. The method according to claim 15, further comprising:
receiving, by the client from the cash registering device, a firmware version number of the cash registering device;
forwarding, by the client, the firmware version number of the cash registering device to the server so that the server can verify the firmware version number of the cash registering device.

27. A method comprising:
transmitting, by a cash registering device to a client, a wireless signal comprising an identifier of the cash registering device, the cash registering device comprising a mobile computing device capable of transmitting the wireless signal to facilitate making a payment;
establishing, by the cash registering device, a wireless connection with the client;
generating, by the cash registering device, a session identifier;
transmitting, by the cash registering device to the client, the session identifier via the established wireless connection;
receiving, by the cash registering device from the client, a transaction result associated with a payment transaction and the session identifier; and
verifying, by the cash registering device, that the received session identifier matches the generated session identifier.

28. The method according to claim 27, wherein the verifying further comprises generating, by the cash registering device, voice information according to the transaction result and playing the voice information.

29. The method according to claim 27, further comprising:
transmitting, by the cash registering device to the client, a firmware version number of the cash registering device .

30. A method comprising:
receiving, by a client, a wireless broadcast signal from a cash registering device;
extracting, by the client, an identifier of the cash registering device from the wireless broadcast signal;
receiving, by the client, transaction information input by a user;
packaging, by the client, the identifier of the cash registering device and the transaction information into first information;
transmitting, by the client, the first information to a server;
receiving, by the client, a transaction result from the server; and
transmitting, by the client, the received transaction result to the cash registering device.

31. The method according to claim 30, further comprising:
querying, by the client from the server, information of a merchant corresponding to the identifier of the cash registering device; and
displaying, by the client, the information.

32. The method according to claim 30, further comprising:
receiving, by the client, transaction result confirmation information from the cash registering device; and
transmitting, by the client, the transaction result confirmation information to the server.

33. The method according to claim 30, further comprising receiving, by the client, a session identifier from the server; and
transmitting, by the client, the received session identifier to the cash registering device.

34. The method according to claim 30, further comprising:
receiving, by the client from the cash registering device, a firmware version number of the cash registering device; and
verifying, by the client, the firmware version number of the cash registering device.

35. The method according to claim 30 wherein the transaction information comprises a transaction amount.
